(19) United States
(12) Patent Application Publication
(10) Pub. No.: US 2026/0167864 A1
(43) Pub. Date: Jun. 18, 2026

(54) PHOSPHOR, METHOD FOR PRODUCING A PHOSPHOR AND RADIATION-EMITTING DEVICE

(71) Applicant: ams-OSRAM International GmbH, Regensburg (DE)

(72) Inventors: Juliane KECHELE, Stadtbergen (DE); Johanna STRUBE-KNYRIM, Weil (DE); Frauke PHILIPP, Augsburg (DE); Daniel BICHLER, Augsburg (DE); Gina Maya ACHRAINER, Greifenberg (DE); Mark VORSTHOVE, Augsburg (DE); Simon DALLMEIR, Landsberg am Lech (DE); Gudrun PLUNDRICH, Landsberg am Lech (DE); Christian KOCH, Oberottmarshausen (DE)

(21) Appl. No.: 18/711,133

(22) PCT Filed: Nov. 3, 2022
(86) PCT No.: PCT/EP2022/080661

§ 371 Date: May 17, 2024

(30) Foreign Application Priority Data
Nov. 17, 2021 (DE) 10 2021 130 040.1

(51) Int. Cl. C09K 11/77; C01B 21/082; H05B 6/72

(52) U.S. Cl. CPC C09K 11/77347; C01B 21/0823; C09K 11/77217; H05B 6/72; C01P 2002/76; C01P 2006/60

(57) ABSTRACT

The present disclosure provides a phosphor having the general molecular formula EA₄Li₂D₄₋ₓEₓN₈₋ₓO₁₋ₓ:M. EA is an element or a combination of elements selected from the group of divalent elements, D is an element or a combination of elements selected from the group of tetravalent elements and E is an element or a combination of elements selected from the group of trivalent elements. Furthermore, M comprises an activator element and 0≤x≤4. A method for producing the phosphor and a radiation-emitting device are also provided.

### CROSS-REFERENCE TO RELATED APPLICATIONS

This application is a 371 U.S. National Phase of PCT International Patent Application No. PCT/EP2022/080661, filed on Nov. 3, 2022, which claims priority from German Patent Application No. 10 2021 130 040, filed on Nov. 17, 2021, the disclosures of which are incorporated by reference herein in their entirety for all purposes.

### TECHNICAL FIELD

The present disclosure relates to phosphor, a method for producing phosphor and a radiation-emitting device.

### SUMMARY

A phosphor and a method for producing a phosphor are disclosed. A radiation-emitting device is also disclosed.

An object is to provide a phosphor with an increased efficiency. Furthermore, it is an object to provide a method for producing such a phosphor and a radiation-emitting device with a high spectral efficiency.

### BRIEF DESCRIPTION OF THE DRAWINGS

Further advantageous embodiments, configurations and developments of the phosphor, the method for producing a phosphor and the radiation-emitting device are arise from the following exemplary embodiments illustrated with the figures.

FIG. 1 shows a schematic representation of a phosphor according to an exemplary embodiment.

FIG. 2 shows a schematic section of a crystal structure of a host lattice of a phosphor according to an exemplary embodiment.

FIG. 3 shows an emission spectrum of a phosphor according to an exemplary embodiment.

FIG. 4 shows emission spectra of two phosphors, each according to an exemplary embodiment.

FIG. 5 shows emission spectra of a phosphor according to an exemplary embodiment and a comparative example.

FIG. 6 shows emission spectra of a phosphor according to an exemplary embodiment and a comparative example.

FIG. 7 schematically shows various steps of a method for producing a phosphor according to an exemplary embodiment.

FIG. 8 shows a radiation-emitting device in schematic sectional view according to an exemplary embodiment.

Elements that are identical, similar or have the same effect are marked with the same reference signs in the figures. The figures and the proportions of the elements shown in the figures should not be considered to be to scale. Rather, individual elements, in particular layer thicknesses, may be shown in exaggerated size for better visualization and/or understanding.

### DETAILED DESCRIPTION

A phosphor is provided. According to an embodiment, the phosphor obeys the general molecular formula EA₄Li₂D₄₋ₓEₓN₈₋ₓO₁₊ₓ:M.

Here and in the following, phosphors are described using molecular formulas. The elements listed in the molecular formulas are present in charged form. Here and in the following, with reference to the molecular formulas of phosphors, elements and atoms therefore refer to ions in the form of anions and cations, even if this is not explicitly stated. This also applies to element symbols if they are mentioned without a charge number for the sake of clarity.

It is possible for the phosphor to comprise further elements in the form of impurities in the given molecular formulae. In particular, these impurities comprise at most 5 mol %, in particular at most 1 mol %, preferably at most 0.1 mol %.

The phosphor is usually uncharged on the outside. This means that there can be a complete charge balance between positive and negative charges on the outside of the phosphor. However, it is also possible that the phosphor does not have a complete charge balance to a small extent.

According to an embodiment of the phosphor, EA is an element or a combination of elements selected from the group of divalent elements.

The term “valency” in relation to a specific element refers to how many elements with a single opposite charge are required in a chemical compound in order to achieve a charge balance. The term “valency” therefore includes the charge number of the element.

Elements with a valency of two are called divalent elements. Divalent elements are often doubly positively charged in chemical compounds and have a charge number of +2. A charge balance in a chemical compound can take place, for example, via two other elements that are singly negatively charged or another element that is doubly negatively charged.

According to an embodiment, D is an element or a combination of elements selected from the group of tetravalent elements.

Tetravalent elements are elements with a valency of four. Tetravalent elements are often positively charged four times in chemical compounds and have a charge number of +4. A charge balance in a chemical compound can take place, for example, via an element that is negatively charged four times, by two elements that are negatively charged twice, or four elements that are negatively charged once.

According to an embodiment of the phosphor, E is an element or a combination of elements from the group of trivalent elements.

Trivalent elements are elements with a valency of three. Trivalent elements often have a triple positive charge in chemical compounds and have a charge number of +3. A charge balance in a chemical compound can take place, for example, via an element that has a triple negative charge or via three elements that have a single negative charge.

According to an embodiment of the phosphor, M comprises an activator element. Generally, the phosphor comprises a host lattice into which foreign elements are introduced as activator elements. An activator element in the host lattice can absorb electromagnetic radiation of a first wavelength range, whereby an electronic transition takes place in the activator element from a ground state to an excited state. It is also possible that the host lattice absorbs the electromagnetic radiation of the first wavelength range and transfers the energy thus absorbed to the activator element, whereby the electronic transition in the activator element is excited. In both cases, the activator element returns from the excited state to the ground state by emitting electromagnetic radiation of a second wavelength range with an emission spectrum.

In other words, the electromagnetic radiation of the first wavelength range is an excitation wavelength of the phosphor. Generally, the electromagnetic radiation of the first wavelength range is at least partially different from the electromagnetic radiation of the second wavelength range.

In particular, M is an element or a combination of elements from the group comprising the rare earth metals, Cr, Ni and Mn. The rare earth elements in the present case comprise the chemical elements of the third subgroup of the periodic table and the lanthanides. Rare earth elements are presently generally selected from the group consisting of Sc, Y, La, Ce, Pr, Nd, Pm, Sm, Eu, Gd, Tb, Dy, Ho, Er, Tm, Yb and Lu. In particular, the activator element M is present as a divalent, trivalent or tetravalent element.

According to an embodiment of the phosphor, 0≤x≤4. In other words, x is greater than or equal to 0 and less than or equal to 4.

According to a preferred embodiment of the phosphor, the phosphor obeys the general molecular formula EA₄Li₂D₄₋ₓEₓN₈₋ₓO₁₊ₓ:M, wherein EA is an element or a combination of elements selected from the group of divalent elements, D is an element or a combination of elements selected from the group of tetravalent elements, E is an element or a combination of elements selected from the group of trivalent elements, M comprises an activator element, and 0≤x≤4.

According to an embodiment of the phosphor, EA is an element or a combination of elements selected from the group consisting of Mg, Ca, Sr and Ba.

According to an embodiment of the phosphor, D is an element or a combination of elements selected from the group consisting of Si and Ge.

According to an embodiment of the phosphor, E is an element or a combination of elements selected from the group consisting of B, Al and Ga.

According to an embodiment of the phosphor, M is an element or a combination of elements selected from the group consisting of Eu and Ce. Europium is present in particular in the form Eu²⁺. Cerium is present in particular in the form Ce³⁺. For example, M is Ce, Eu or a combination of Ce and Eu.

With conventional phosphors comprising Eu²⁺ as an activator element, quenching effects occur even at low irradiance levels, for example around 100 mW/mm². This leads to a reduction in quantum efficiency. For phosphors comprising Ce³⁺ as an activator element, lower quenching effects are observed even at high irradiance levels compared to Eu²⁺-activated phosphors. For example, a phosphor with the molecular formula Y₃Al₅O₁₂:Ce³⁺ only exhibits quenching effects at irradiance levels of at least 10 W/mm², i.e. more than one order of magnitude above the irradiance levels at which quenching effects occur with Eu²⁺-activated phosphors.

The fact that Ce³⁺-activated phosphors comprise lower quenching effects even at high irradiances can be attributed to the fact that an excited state of Ce³⁺ has a significantly lower lifetime than an excited state of Eu²⁺. In particular, a typical excited state lifetime of Ce³⁺ is less than 100 nanoseconds, whereas a typical excited state lifetime of Eu²⁺ is in the range of one microsecond to 10 microseconds.

According to an embodiment of the phosphor, the phosphor obeys the molecular formula EA₄Li₂Si₄N₈O:M. In particular, EA is an element or a combination of elements selected from the group comprising Mg, Ca, Sr and Ba. In other words, in the general molecular formula EA₄Li₂D₄₋ₓEₓN₈₋ₓO₁₊ₓ:M x is 0 and Si is selected for the element D.

According to an embodiment of the phosphor, the phosphor obeys the molecular formula Sr₄Li₂Si₄N₈O:M. In other words, in the general molecular formula EA₄Li₂D₄₋ₓEₓN₈₋ₓO₁₊ₓ:M x is chosen to be 0, the element D is chosen to be Si and the element EA is chosen to be Sr.

According to an embodiment of the phosphor, the activator element M comprises a molar proportion of between and including 0.01% and 10% based on the element EA. In particular, M comprises a molar proportion of between and including 0.01% and 5% based on the element EA.

According to an embodiment of the phosphor, the phosphor obeys the molecular formula EA_{4-y}M_{y}Li₂Si₄N₈O. Where y is a value between and including 0.0004 and 0.4. The molecular formula EA_{4-y}M_{y}Li₂Si₄N₈O is an alternative notation to the molecular formula EA₄Li₂Si₄N₈O:M. The molecular formula EA_{4-y}M_{y}Li₂Si₄NO makes it clear that the activator element M can occupy the same crystallographic positions as the element EA.

According to an embodiment of the phosphor, the phosphor comprises a host lattice with a tetragonal space group. In particular, the host lattice is a crystalline host lattice. For example, the phosphor comprises a host lattice with the space group P4/mnc.

According to an embodiment of the phosphor, a crystal structure of the host lattice of the phosphor comprises DN₄-tetrahedra and/or EN₄-tetrahedra. For example, the crystal structure of the host lattice of the phosphor comprises DN₄-tetrahedra, in particular SiN₄-tetrahedra.

The DN₄-tetrahedra and the EN₄-tetrahedra are preferably spanned by four N atoms each. In particular, all N atoms that span a tetrahedron have a similar distance to a central D atom or a central E atom. In other words, the D atom or the E atom is surrounded by four N atoms in a tetrahedron shape. The DN₄-tetrahedra and the EN₄-tetrahedra may comprise a tetrahedral gap. The tetrahedral gap is an area inside the respective tetrahedron. For example, the term “tetrahedral gap” is used to describe the area inside the tetrahedron that remains free when spheres are placed in the corners of the tetrahedron that are thought to be touching.

In particular, the DN₄-tetrahedra and/or the EN₄-tetrahedra are corner-linked on all sides. Corner-linked on all sides means that each tetrahedron is linked with one corner of another tetrahedron via all four corners. The corner-linked tetrahedra form an interconnected network.

According to an embodiment of the phosphor, the crystal structure of the host lattice comprises four-rings of DN₄-tetrahedra and/or EN₄-tetrahedra. In particular, a four-ring consists of a total of four DN₄-tetrahedra and/or EN₄-tetrahedra, which are corner-linked on all sides. Channels are preferably formed by the four-rings.

In the case wherein x is greater than 0, some of the N atoms are replaced by O atoms. In other words, in this case the phosphor may comprise D(N,O)₄-tetrahedra and/or E(N,O)₄-tetrahedra. All the characteristics listed with the DN₄-tetrahedra and EN₄ tetrahedra also apply to the D(N,O)₄-tetrahedra and E(N,O)₄-tetrahedra. In particular, the D(N,O)₄-tetrahedra and/or E(N,O)₄-tetrahedra replace part of the DN₄-tetrahedra and/or the EN₄-tetrahedra.

According to at least one embodiment of the phosphor, O atoms are present as free O²⁻ anions in the channels formed by the four-rings. Preferably, the O atoms are not bonded to a D atom or E atom, in particular a Si atom. Preferably, Li⁺ cations are also present in the channels.

In particular, the Lit cations are each surrounded by four N atoms and one O atom in a square pyramid. The four N atoms form the base of a square pyramid and the O atom forms the tip of the square pyramid. In other words, Li₂O is located as a strand in the channels formed by the four-rings.

According to an embodiment of the phosphor, the host lattice comprises a BCT zeolite-like structure. Typically, a BCT zeolite comprises four-rings and eight-rings of tetrahedra along the crystallographic direction [001] and six-rings of tetrahedra along the crystallographic directions [100] and [010].

According to an embodiment of the phosphor, the phosphor comprises an absorption range at least partially in the ultraviolet to blue wavelength range of the electromagnetic spectrum. For example, the phosphor absorbs electromagnetic radiation with a wavelength of approximately 405 nanometers or approximately 448 nanometers.

According to an embodiment of the phosphor, an electromagnetic radiation emitted by the phosphor comprises an emission spectrum with at least one emission peak.

The emission spectrum is the distribution of the electromagnetic radiation emitted by the phosphor after excitation with electromagnetic radiation of the first wavelength range. The emission spectrum is usually represented in the form of a diagram in which a spectral intensity or a spectral radiant flux per wavelength interval (“spectral intensity/spectral radiant flux”) of the electromagnetic radiation emitted by the phosphor is shown as a function of the wavelength A. In other words, the emission spectrum represents a curve in an x/y diagram in which the wavelength is plotted on the x-axis and the spectral intensity or spectral radiant flux is plotted on the y-axis.

According to an embodiment of the phosphor, the emission maximum of the emission peak is in the cyan to green wavelength range of the electromagnetic spectrum. For example, the emission maximum is in a range of between and including 480 nanometers and 550 nanometers, preferably from between and including 495 nanometers and 540 nanometers, particularly preferably from between and including 500 nanometers and 535 nanometers. For example, the phosphor comprises an emission maximum at 512 nanometers or 523 nanometers. In particular, the phosphor with cyan to green emission comprises Ce as activator element. In other words, the phosphor with cyan to green emission is a Ce³⁺-activated phosphor.

The phosphor with cyan to green emission can be used with advantage in white light LEDs and human centric lighting applications. In particular, a higher color rendering index is observed in white light LEDs with the phosphor described herein compared to conventional white light LEDs.

Human-centric lighting applications are, in particular, human-centered lighting concepts that take into account both purely visual and non-visual effects of electromagnetic radiation. Many of these effects, such as increased attention and alertness under appropriate lighting, are now attributed to activation of the photoreceptor melanopsin in the eye. The ability of electromagnetic radiation to stimulate this receptor is evaluated, for example, with the “melanopic efficacy of luminous radiation” (melanopic ELR).

For example, the melanopic ELR of the phosphor described herein is at least 0.72. In contrast, the melanopic ELR of a conventional phosphor, for example YAGaG:Ce³⁺, is about 0.62. In particular, the melanopic ELR of the phosphor described herein exceeds the melanopic ELR of a conventional phosphor by up to 46%.

According to an embodiment of the phosphor, the emission maximum of the emission peak is in the deep red to near-infrared wavelength range of the electromagnetic spectrum. In particular, the emission maximum is in a range from between and including 770 nanometers and 820 nanometers, preferably from between and including 780 nanometers and 810 nanometers. For example, the phosphor comprises an emission maximum at 793 nanometers. In particular, the phosphor with deep red to near-infrared emission comprises Eu as activator element. In other words, the phosphor with deep red to near-infrared emission is a Eu²⁺-activated phosphor.

The phosphor with deep red to near-infrared emission can advantageously be used in spectroscopic applications, for example for spectroscopic investigations of biological samples. Electromagnetic radiation in the near-infrared window is used in particular for the spectroscopic examination of biological samples. The near-infrared window is in the wavelength range from around 650 nanometers to around 1350 nanometers. In this wavelength range, light can propagate as far as possible through biological tissue. The phosphor described here is advantageous for such an application in that it emits electromagnetic radiation in a wavelength range from 710 nanometers to 910 nanometers, i.e. exactly in the range of the near-infrared window.

Advantageously, the phosphor with deep red to near-infrared emission can also be used in devices with a health-promoting effect, for example in “IR-enhanced human centric lighting” applications and as a component for LEDs to support eye regeneration and treat eye conditions. Electromagnetic radiation in a wavelength range from around 600 nanometers to around 1000 nanometers is used in particular to treat eye conditions.

It is possible that the emission spectrum of the phosphor comprises at least two emission maxima. A first emission maximum is in the green wavelength range of the electromagnetic spectrum, for example. A second emission maximum can be in the deep red to near-infrared wavelength range of the electromagnetic spectrum. In particular, the phosphor with at least two emission maxima comprises two different elements as activator elements, for example Ce and Eu.

In particular, the position of the emission maximum can be adjusted by the molar proportion of the activator element.

According to an embodiment of the phosphor, the emission peak in the emission spectrum of the phosphor comprises a full-width at half maximum (FWHM) between and including 100 nanometers and 220 nanometers, preferably between and including 105 nanometers and 210 nanometers, particularly preferably between and including 120 nanometers and 200 nanometers. For example, the emission peak comprises a full-width at half maximum of 133 nanometers or 197 nanometers. In particular, the phosphor described here is a phosphor with broadband emission.

The term full-width at half maximum refers to a curve with a maximum, such as the emission spectrum, where the full-width at half maximum is the region on the x-axis corresponding to the two y-values corresponding to half of the maximum.

Compared to conventional phosphors, in particular Lu₃(Al,Ga)₅O₁₂:Ce³⁺ and Ca₈Mg(SiO₄)₄Cl₂:Eu²⁺, the phosphor described herein advantageously comprises a larger full-width at half maximum.

According to an embodiment of the phosphor, the electromagnetic radiation emitted by the phosphor comprises a dominant wavelength λ_{dom} between and including 520 nanometers and 585 nanometers, preferably between and including 530 nanometers and 575 nanometers, particularly preferably between and including 535 nanometers and 570 nanometers. For example, a dominant wavelength of the electromagnetic radiation emitted by the phosphor is 545 nanometers or 558 nanometers.

To determine the dominant wavelength of the electromagnetic radiation emitted by the phosphor, a straight line is drawn in the CIE standard diagram from the white point through the color locus of the electromagnetic radiation. The intersection of the straight line with the spectral color line delimiting the CIE standard diagram denotes the dominant wavelength of the electromagnetic radiation. In general, the dominant wavelength deviates from the wavelength of the emission maximum.

According to an embodiment of the phosphor, the electromagnetic radiation emitted by the phosphor comprises a centroid wavelength λ_{centroid} between and including 795 nanometers and 845 nanometers, preferably between and including 805 nanometers and 835 nanometers, particularly preferably between and including 810 nanometers and 830 nanometers. For example, the centroid wavelength of the electromagnetic radiation emitted by the phosphor is 819 nanometers.

The centroid wavelength designates the centroid of a spectral distribution of an emission spectrum. In other words, the centroid wavelength indicates where the center of the emission spectrum is located. The centroid wavelength is calculated as the weighted arithmetic mean of the wavelengths λ, weighted with their amplitudes using the distribution function s (A):

$${λ}_{centroid} = \frac{{\int }_{- ∞}^{∞} λ \cdot s ( λ ) d λ}{{\int }_{- ∞}^{∞} s ( λ ) d λ} .$$

A method for producing a phosphor is further specified. Preferably, the phosphor according to the embodiments mentioned above is produced with the method described herein. Therefore, in particular, all specifications made for the phosphor also apply to the method and vice versa.

According to an embodiment of the method for producing a phosphor which obeys the general molecular formula EA₄Li₂D₄₋ₓEₓN₈₋ₓO₁₊ₓ:M wherein
EA is an element or a combination of elements selected from the group of divalent elements,
D is an element or a combination of elements selected from the group of tetravalent elements,
E is an element or a combination of elements selected from the group of trivalent elements,
M comprises an activator element, and

$$0 \leq x \leq 4 ,$$

reactants are provided.

According to an embodiment of the method, the reactants are mixed to form a reactant mixture. In particular, the reactants are mixed in a hand mortar, a mortar mill, a ball mill or a multi-axis mixer.

Preferably, the reactant mixture is transferred to a crucible. The crucible is made of corundum, nickel or tungsten, for example.

According to an embodiment of the method, the reactant mixture is heated. In particular, the reactant mixture is heated for a time of at least 8 hours, preferably at least 16 hours. For example, the heating is carried out for 16 hours.

In particular, the phosphor is formed by the heating. After heating, the phosphor formed can be ground, for example in a hand mortar, a mortar mill or a ball mill.

For example, it is possible that a mixture comprising or consisting of the phosphor is produced by the method. Other components of the mixture can be, for example, reactants which have not reacted during the producing of the phosphor, impurities and/or secondary phases which were formed during production.

According to an embodiment of the method, the reactants are selected from a group formed from the following materials: oxides, nitrides, fluorides, oxalates, citrates, carbonates, amines, imides of EA, Li, D, E and M. In particular, oxides and nitrides of EA, Li, D, E and M are used as reactants. For example, the reactants are selected from a group formed from the following materials: SrO, Sr₃N₂, SiO₂, Si₃N₄, Li₂O, Li₃N, Eu₂O₃, CeO₂.

According to an embodiment of the method, the reactant mixture is heated at a pressure of at least 50 bar, preferably at least 80 bar. For example, heating takes place at a pressure of 100 bar. The method described herein for producing a phosphor is in particular a high-pressure method. In particular, the high-pressure method can be used to produce phosphors that cannot be produced with conventional methods carried out at normal pressure.

According to an embodiment of the method, the reactant mixture is heated under an atmosphere of N₂, forming gas and/or NH₃. In other words, the phosphor is produced in a reducing atmosphere. The reducing atmosphere makes it possible to use reactants that are not oxides or nitrides. Furthermore, the oxides and nitrides can be used in any ratio, since the oxides in particular are converted into the corresponding nitrides in situ, i.e. during the production of the phosphor.

According to an embodiment of the method, the reactant mixture is heated to a temperature of at least 800° C., preferably at least 900° C. For example, the reactant mixture is heated to a temperature of 900° C.

A radiation-emitting device comprising a phosphor is further specified. Preferably, the phosphor described above is suitable and intended for use in the radiation-emitting device described herein. Features and embodiments described with the phosphor and/or the method also apply to the radiation-emitting device and vice versa.

According to an embodiment of the radiation-emitting device, the radiation-emitting device comprises a semiconductor chip which emits electromagnetic radiation of a first wavelength range during operation.

In particular, the semiconductor chip comprises a semiconductor layer sequence that comprises an active region. The active region is configured to generate the electromagnetic radiation of the first wavelength range during operation of the radiation-emitting device. For example, the semiconductor layer sequence is applied to a substrate. The semiconductor chip is, for example, a light-emitting diode chip or a laser diode chip. The electromagnetic radiation of the first wavelength range is emitted through a radiation exit surface of the semiconductor chip.

The first wavelength range comprises in particular wavelengths in the ultraviolet to blue wavelength range of the electromagnetic spectrum. For example, the semiconductor chip emits electromagnetic radiation of the blue spectral range, in particular of between and including 380 nanometers and 550 nanometers, preferably of between and including 420 nanometers and 500 nanometers, particularly preferably of between and including 430 nanometers and 480 nanometers.

According to an embodiment of the radiation-emitting device, the radiation-emitting device comprises a conversion element with the phosphor described herein, which converts electromagnetic radiation of the first wavelength range into electromagnetic radiation of a second wavelength range. In particular, the electromagnetic radiation of the first wavelength range is at least partially, preferably completely, different from the second wavelength range.

The radiation-emitting device is, for example, a light-emitting diode (LED).

Advantageously, the phosphor described herein can be used as a single component, i.e. without another phosphor, in a conversion element. This is made possible by the fact that the radiation-emitting device with the phosphor described herein comprises a higher color rendering index (CRI) than a radiation-emitting device with a conventional phosphor. In particular, the color rendering index of the radiation-emitting device with the phosphor described here is at least 35. With conventional phosphors, only a color rendering index of less than 35 can be achieved for a similar radiation-emitting device.

According to an embodiment of the radiation-emitting device, the conversion element comprises at least one further phosphor which converts electromagnetic radiation of the first wavelength range into electromagnetic radiation of a third wavelength range. In particular, the third wavelength range is at least partially, preferably completely, different from the first wavelength range and/or the second wavelength range. The third wavelength range can comprise wavelengths in the green, yellow, orange and/or red spectral range.

Alternatively, the third wavelength range can include wavelengths above 1000 nanometers. In other words, a further phosphor is used in the conversion element that emits IR radiation. As a result, the electromagnetic radiation emitted by the radiation-emitting device at least partially covers the red, the deep red and the near-infrared spectral range. Such a radiation-emitting device can be used, for example, for spectroscopic examination in biological samples and for “IR-enhanced human centric lighting” applications, which in particular utilize the health-promoting effect of near-infrared radiation.

In particular, only part of the electromagnetic radiation of the first wavelength range is converted by the phosphor and/or by the further phosphor. It is possible that the unconverted part of the electromagnetic radiation of the first wavelength range is transmitted by the conversion element. In other words, a partial conversion of the electromagnetic radiation of the first wavelength range into electromagnetic radiation of the second wavelength range and/or the third wavelength range takes place. In this case, the radiation-emitting device emits a mixed light composed of the electromagnetic radiation of the first wavelength range, the second wavelength range and the third wavelength range.

For example, a phosphor described herein with the general molecular formula EA₄Li₂D₄₋ₓEₓN₈₋ₓO₁₊ₓ:M is used in the conversion element, wherein M is Ce. As a further phosphor, a phosphor described herein with the general empirical formula EA₄Li₂D₄₋ₓEₓN₈₋ₓO₁₊ₓ:M can be used, wherein M is Eu. Alternatively or additionally, a phosphor described herein with both Ce and Eu as activator element can be used in the conversion element. This makes it possible in particular to cover two wavelength ranges with a single phosphor.

The further phosphor can also be, for example, garnet-like phosphors or garnets such as YAG, YAGaG, LuAG and/or LuAGaG, for example (Y,Lu)₃(Al,Ga)₅O₁₂:Ce³⁺. Alternatively or additionally, a red phosphor such as a 258-nitride, for example (Ca,Sr,Ba)₂Si₅N₈:Eu²⁺, and/or (S)CASN, for example (Ca,Sr)AlSiN₃:Eu²⁺, can be used as the further phosphor. The radiation-emitting device emits white light in particular when the further phosphor is used and can be used in “human centric lighting” applications.

In conventional radiation-emitting devices, mixtures of different phosphors are used in particular to produce white mixed light. For example, a Ce³⁺-activated garnet phosphor, for example (Y,Lu)₃(Al,Ga)₅O₁₂:Ce³⁺, and a Eu²⁺-activated nitride phosphor are used in conventional radiation-emitting devices. With such radiation-emitting devices, however, there is always an emission gap in the cyan wavelength range, i.e. in the range between the blue wavelength range emitted by the semiconductor chip and a green or yellow wavelength range emitted by the garnet phosphor.

A Ce³⁺-activated phosphor described herein emits in particular broadband in the cyan to green wavelength range. Therefore, the phosphor described herein can with advantage replace the garnet phosphor of the conventional radiation-emitting device. Since the phosphor described herein already emits in the cyan wavelength range, the emission gap in this range, which occurs in conventional radiation-emitting devices, is closed. Due to this property, the phosphor described herein can be used advantageously in “human centric lighting” applications.

Up to now, conventional phosphors such as Lu₃(Al,Ga)₅O₁₂:Ce³⁺ and/or Ca₈Mg(SiO₄)₄Cl₂:Eu²⁺ have been used in human centric lighting applications. An emission peak of the two conventional phosphors in the cyan to green wavelength range comprises a small half-width of less than or equal to 115 nanometers. In particular, the use of Lu₃(Al,Ga)₅O₁₂:Ce³⁺ to generate white light results in emission gaps in the cyan and/or yellow-orange wavelength range of the electromagnetic spectrum. For example, with Ca₈Mg(SiO₄)₄Cl₂:Eu²⁺ an emission gap in the yellow-orange wavelength range can be observed. The emission gaps in the cyan and/or yellow-orange wavelength range must be closed at great expense by adapting a red phosphor component or using a further phosphor. If the red phosphor component is not adapted or a further phosphor is not used, this results in a loss of light quality.

The phosphor described herein comprises sufficient emission, in particular in the cyan wavelength range, with other words in the wavelength range from between and including 475 nanometers and 500 nanometers, so that no emission gap occurs in this wavelength range compared to conventional phosphors. The phosphor described herein thus leads in particular to an increase in light quality.

In particular, by using the phosphor described herein, radiation-emitting devices can be provided that comprise a higher melanopic ELR, a higher relative melanopic ELR and a higher color rendering index (CRI) compared to conventional radiation-emitting devices.

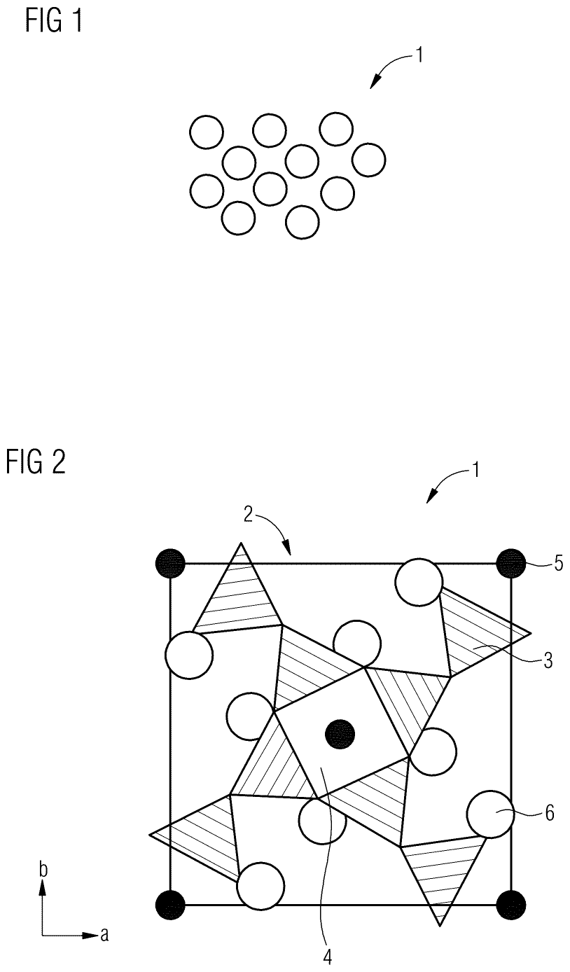

FIG. 1 shows a phosphor 1 according to an exemplary embodiment in schematic illustration. The phosphor 1 obeys the general molecular formula EA₄Li₂D₄₋ₓEₓN₈₋ₓO₁₊ₓ:M. EA is an element or a combination of elements selected from the group of divalent elements, D is an element or a combination of elements selected from the group of tetravalent elements and E is an element or a combination of elements selected from the group of trivalent elements. Furthermore, M comprises an activator element and 0≤x≤4. In particular, the phosphor 1 obeys the molecular formula Sr₄Li₂Si₄N₈O:M, where M is Ce or Eu.

The phosphor 1 according to the exemplary embodiment of FIG. 1 has the form of particles. For example, the particles comprise a particle size of between and including 0.5 micrometers and 100 micrometers.

FIG. 2 shows a schematic section of a crystal structure of a host lattice 2 of a phosphor 1 according to an exemplary embodiment. Presently, the host lattice 2 of phosphor 1 obeys the molecular formula Sr₄Li₂Si₄N₈O. In particular, activator elements such as Ce and Eu are introduced into the host lattice. Presently, the host lattice 2 of the phosphor 1 crystallizes in the tetragonal space group P4/mnc. The schematic section of the host lattice 2 is shown from the viewing direction of the crystallographic c-axis.

The crystal structure of the host lattice 2 of the phosphor 1 presently comprises SiN₄-tetrahedra 3. The SiN₄-tetrahedron 2 is Si-centered. The four N atoms of a SiN₄-tetrahedron comprise a similar distance to the central Si atom. The SiN₄-tetrahedra 3 are corner-linked on all sides. In this way, a network is formed. The SiN₄-tetrahedra 3 are cross-linked into four-rings, wherein channels 4 are formed. Li atoms 5 and O atoms are located in the channels. Due to the choice of the schematic section of the crystal structure of the host lattice, the O atoms are not shown in FIG. 2. The O atoms are present as free anions (O²⁻) in the channels 4. With other words, the O atoms are not bonded to a Si atom. The Li atom 5 is coordinated square pyramidally by four N atoms and one O atom. The four N atoms form the base of a square pyramid and the O atom forms the tip.

For embodiments of phosphor 1 with the general molecular formula EA₄Li₂D₄₋ₓEₓN₈₋ₓO₁₊ₓ:M with x greater than 0, some of the SiN₄-tetrahedra are replaced by Si(N,O)₄-tetrahedra. In other words, the additional O atoms proportionally occupy the crystallographic positions of the N atoms.

The corner linkage of the SiN₄-tetrahedra 3 also forms eight-rings and six-rings. The six-rings run along the crystallographic a-axis ([100] direction) and the crystallographic b-axis ([010] direction). The four-rings and the eight-rings run along the crystallographic c-axis ([001] direction).

The crystal structure of the host lattice of the phosphor 1 according to the present exemplary embodiment is similar to the structure of a BCT zeolite.

The crystal structure of the host lattice 2 of the phosphor 1 also comprises Sr atoms 6. The Sr atoms 6 are arranged between the SiN₄-tetrahedra 3. In particular, not only Sr occupies the crystallographic position of the Sr atoms 6, but also the activator element, for example Ce or Eu.

General crystallographic data of the phosphors 1 according to the exemplary embodiments with the molecular formulae Sr₄Li₂Si₄N₈O:Ce³⁺ and Sr₄Li₂Si₄NO:Eu²⁺ are summarized in Table 1.

TABLE 1
Crystallographic data of
Sr₄Li₂Si₄N₈O:Ce³⁺ and
Sr₄Li₂Si₄N₈O:Eu²⁺.

| molecular formula | Sr₄Li₂Si₄N₈O:Eu²⁺ | Sr₄Li₂Si₄N₈O:Ce³⁺ |
|---|---|---|
| Formula mass/g mol⁻¹ | 604.76 | 604.76 |
| Z | 2 | 2 |
| crystal system | tetragonal | tetragonal |
| space group | P4/mnc | P4/mnc |
| lattice parameters | | |
| a/pm 931.94(12) | α/°90 | a/pm 930.82(8) α/°90 |
| b/pm 931.94(12) | β/°90 | b/pm 930.82(8) β/°90 |
| c/pm 558.12(9) | γ/°90 | c/pm 557.12(7) γ/°90 |
| volume V/nm³ | 0.48473(15) | 0.48270(10) |
| Crystallographic | 4.144 | 4.161 |
| density ρ/g cm⁻³ | | |
| T/K | 296 (2) | 296(2) |
| diffractometer | Bruker D8 Quest | Bruker D8 Quest |
| radiation | Cu K_{α} (154.178 nm) | Cu K_{α} (154.178 nm) |
| measuring range | 6.718° ≤ | 6.726° ≤ |
| | θ ≤ 68.258° | θ ≤ 50.894° |
| measured/independent | 3706/251 | 150/132 |
| reflexes | | |
| measured reciprocal | −9 ≤ h ≤ 11; | −8 ≤ h ≤ 9; |
| space | −10 ≤ k ≤ 11; | −6 ≤ k ≤ 8; |
| | −6 ≤ l ≤ 6 | −5 ≤ l ≤ 5 |
| Rₐₗₗ/wR_{ref} | 4.46%/7.30% | 4.36%/8.37% |
| GooF | 1.005 | 1.243 |

Crystallographic position parameters of the phosphors 1 according to the exemplary embodiments with the molecular formulae Sr₄Li₂Si₄N₈O:Ce³⁺ and Sr₄Li₂Si₄N₈O:Eu²⁺ are shown in Tables 2 and 3.

TABLE 2
Crystallographic position parameters of Sr₄Li₂Si₄N₈O:Eu²⁺.

| | Atom | Wyckoff | | | | | |
|---|---|---|---|---|---|---|---|
| Name | type | position | x | y | z | occupation | Uₐₙᵢ |
| Sr01 | Sr | 8h | 0.55648(9) | 0.76570(9) | 0.5 | 1 | 0.0161(3) |
| Si02 | Si | 8h | 0.3807(3) | 0.7312(3) | 0 | 1 | 0.0127(5) |
| O03 | O | 2a | 0.5 | 0.5 | 0.5 | 1 | 0.017(3) |
| N04 | N | 8h | 0.5635(8) | 0.7049(9) | 0 | 1 | 0.0161(15) |
| N05 | N | 8g | 0.3260(6) | 0.8260(6) | 0.25 | 1 | 0.0158(15) |
| Li06 | Li | 4e | 0.5 | 0.5 | 0.184(4) | 1 | 0.026(5) |

TABLE 3
Crystallographic position parameters of Sr₄Li₂Si₄N₈O:Ce³⁺.

| | Atom | Wyckoff | | | | | |
|---|---|---|---|---|---|---|---|
| Name | type | position | x | y | z | occupation | Uᵢₛₒ |
| Sr01 | Sr | 8h | 0.23439(12) | 0.55621(13) | 0.5 | 1 | 0.0070(7) |
| Si02 | Si | 8h | 0.1199(4) | 0.2313(4) | 0.5 | 1 | 0.0062(10) |
| O03 | O | 2a | 0.5 | 0.5 | 0.5 | 1 | 0.017(4) |
| N04 | N | 8g | 0.1744(7) | 0.3256(7) | 0.25 | 1 | 0.007(3) |
| N05 | N | 8h | −0.0636(10) | 0.2041(11) | 0.5 | 1 | 0.003(3) |
| Li06 | Li | 4e | 0.5 | 0.5 | 0.183(5) | 1 | 0.013(7) |

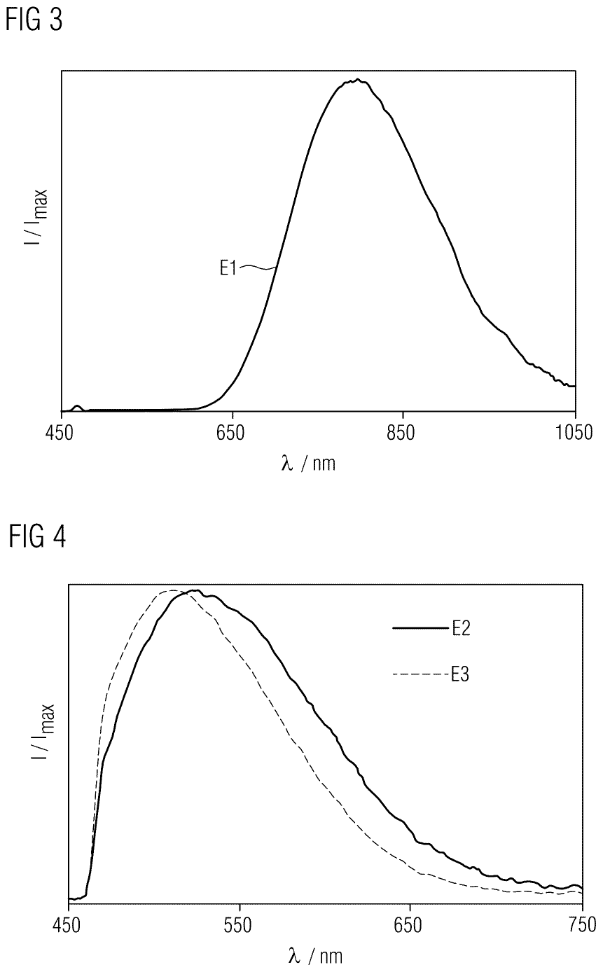

FIG. 3 shows an emission spectrum E1 of a phosphor 1 according to a first exemplary embodiment with the molecular formula Sr₄Li₂Si₄N₈O:Eu²⁺. The emission spectrum E1 is shown presently in a range from 450 nanometers to 1050 nanometers. The phosphor 1 comprises an emission spectrum with an emission maximum at a wavelength of approximately 793 nanometers. The full-width at half maximum of the emission maximum is around 197 nanometers. A centroid wavelength λ_{centroid} is approximately 819 nanometers. The phosphor 1 according to the present exemplary embodiment emits electromagnetic radiation in the deep red to near-infrared range when excited with electromagnetic radiation from the blue range.

FIG. 4 shows emission spectra E2 and E3 of two phosphors 1 according to a second and a third exemplary embodiment. The phosphors 1 comprise the molecular formula Sr₄Li₂Si₄N₈O:Ce³⁺. In particular, the present phosphors 1 differ in their molar proportion of Ce. The emission spectra E2 and E3 are shown in a range from 450 nanometers to 750 nanometers. The phosphors 1 were excited with blue electromagnetic radiation and emit green electromagnetic radiation. The phosphor 1 according to the second exemplary embodiment with the emission spectrum E2 (solid line) comprises an emission maximum at about 523 nanometers with a full-width at half maximum of about 133 nanometers and a dominant wavelength Adom of about 558 nanometers. The phosphor 1 according to the third exemplary embodiment with the emission spectrum E3 (dashed line) comprises an emission maximum at about 512 nanometers with a full-width at half maximum of about 133 nanometers and a dominant wavelength Adom of about 545 nanometers.

FIG. 5 shows emission spectra E2 and VB1 of the phosphor 1 according to the second exemplary embodiment and a first comparative example. The first comparative example is a phosphor with the molecular formula Y₃(Al,Ga)₅O₁₂:Ce³⁺. The emission spectrum E2 is shown as a solid line, the emission spectrum VB1 as a dashed line.

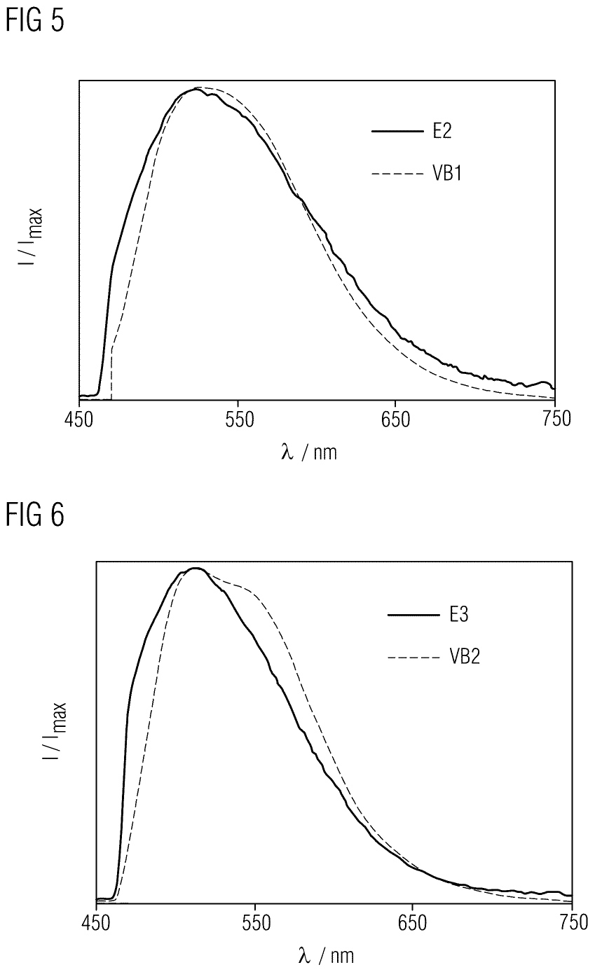

FIG. 6 shows emission spectra E3 and VB2 of phosphor 1 according to the third exemplary embodiment and a second comparative example. The second comparative example is a phosphor with the molecular formula Lu₃Al₅O₁₂:Ce³⁺. The emission spectrum E3 is shown as a solid line, the emission spectrum VB2 as a dashed line.

The emission spectra in FIGS. 5 and 6 are each shown in a range from 450 nanometers to 750 nanometers.

In Table 4, the spectral properties of the phosphor 1 according to the second exemplary embodiment and the third exemplary embodiment are compared with the spectral properties of the first comparative example (Y₃(Al,Ga)₅O₁₂:Ce³⁺) and the second comparative example (Lu₃Al₅O₁₂:Ce³⁺). The phosphors 1 according to the exemplary embodiments comprise improved values for the melanopic ELR and the relative melanopic ELR as well as the color rendering index CRI.

TABLE 4
Comparison of the melanopic ELR and the color rendering indices
(CRI) of the phosphor 1 according to the second and third exemplary
embodiments with the first comparative example (Y₃(Al,Ga)₅O₁₂:Ce³⁺)
and the second comparative example (Lu₃Al₅O₁₂:Ce³⁺).

| | | | second | third |
|---|---|---|---|---|
| | | | exemplary | exemplary |
| phosphor | Y₃(Al,Ga)₅O₁₂:Ce³⁺ | Lu₃Al₅O₁₂:Ce³⁺ | embodiment | embodiment |
| melanopic ELR | 0.6236 | 0.7325 | 0.7219 | 0.9128 |
| relative | 100% | 117% | 116% | 146% |
| melanopic ELR | | | | |
| CRI | 35 | 33 | 48 | 39 |

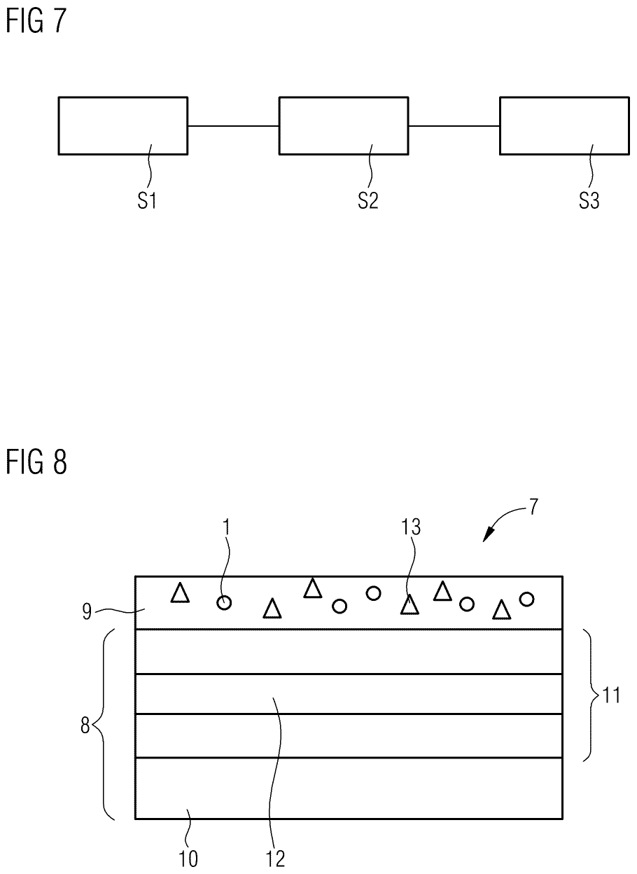

With reference to FIG. 7, a method for producing a phosphor 1 according to an exemplary embodiment is described. The phosphor 1 obeys the general molecular formula EA₄Li₂D₄₋ₓEₓN₈₋ₓO₁₊ₓ:M. In a first method step S1, reactants are provided. For example, the reactants comprise oxides and nitrides of EA, Li, D, E and M.

In a second method step S2, the reactants are mixed together to form a reactant mixture. For example, mixing takes place in a hand mortar, a mortar mill, a ball mill or a multi-axis mixer. The reactants are transferred to a crucible made of corundum, nickel or tungsten, for example.

In a third method step S3, the reactant mixture is heated. Heating takes place in an N₂, forming gas or NH₃ atmosphere at a temperature of at least 800° C. and a pressure of approximately 100 bar. The reactant mixture is heated for a period of approximately 16 hours. After heating, the resulting product is cooled and ground. Grinding takes place, for example, in a hand mortar, a mortar mill or a ball mill.

### Synthesis of Sr₄Li₂Si₄N₈O:Eu²⁺

The reactants Eu₂O₃, SrO, Sr₃N₂, SiO₂, Si₃N₄, Li₂O and Li₃N are mixed together and then transferred to a crucible. The reactant mixture is then reacted in an N₂ atmosphere at approximately 100 bar and approximately 900° C. for approximately 16 hours. After reaction has taken place and cooling, the product is ground. In this way, the phosphor 1 with the molecular formula Sr₄Li₂Si₄N₈O:Eu²⁺ is obtained. The phosphor 1 fluoresces reddish under ultraviolet or blue light.

For the synthesis of Sr₄Li₂Si₄N₈O:Eu²⁺, the reactants are provided in the weights shown in Tables 5 and 6. Sr₄Li₂Si₄N₈O:Eu²⁺ can be produced with the weigh-ins shown in Table 5 as well as with the weigh-ins shown in Table 6.

TABLE 5
Reactant weights for the synthesis of Sr₄Li₂Si₄N₈O:Eu²⁺.

| Element | Reactant | Weigh-in |
|---|---|---|
| Sr | Sr₃N₂ | 2.645 g |
| Li | Li₃N | 0.428 g |
| Si | Si₃N₄ | 0.862 g |
| Eu | Eu₂O₃ | 0.065 g |

TABLE 6
Reactant weights for the synthesis of Sr₄Li₂Si₄N₈O:Eu²⁺.

| Element | Reactant | Weigh-in |
|---|---|---|
| Sr | Sr₃N₂ | 0.1076 |
| Sr | SrO | 0.4599 |
| Li | Li₃N | 0.0258 |
| Li | Li₂O | 0.1326 |
| Si | Si₃N₄ | 0.2075 |
| Si | SiO₂ | 1.0666 |
| Eu | Eu₂O₃ | 0.0200 |

### Synthesis of Sr₄Li₂Si₄N₈O:Ce³⁺

The reactants CeO₂, Sr₃N₂, Si₃N₄ and Li₃N are mixed together and then transferred to a crucible. The reactant mixture is then reacted in an N₂ atmosphere at approximately 100 bar and approximately 900° C. for approximately 16 hours. After the reaction has taken place and cooling, the product is ground. In this way, the phosphor 1 with the molecular formula Sr₄Li₂Si₄N₈O:Ce³⁺ is obtained. The phosphor 1 fluoresces intensely green under ultraviolet or blue light.

For the synthesis of Sr₄Li₂Si₄N₈O:Ce³⁺, the reactants are provided in the weigh-ins shown in Tables 7 and 8.

TABLE 7
Reactant weights for the synthesis of Sr₄Li₂Si₄N₈O:Ce³⁺.

| Element | Reactant | Weigh-in |
|---|---|---|
| Sr | Sr₃N₂ | 2.646 g |
| Li | Li₃N | 0.428 g |
| Si | Si₃N₄ | 0.862 g |
| Ce | CeO₂ | 0.063 g |

TABLE 8
Reactant weights for the synthesis of Sr₄Li₂Si₄N₈O:Ce³⁺.

| Element | Reactant | Weigh-in |
|---|---|---|
| Sr | Sr₃N₂ | 2.536 g |
| Li | Li₃N | 0.152 g |
| Si | Si₃N₄ | 1.070 g |
| Si | SiO₂ | 0.196 g |
| Ce | CeO₂ | 0.045 g |

FIG. 8 shows a schematic sectional view of a radiation-emitting device 7 according to an exemplary embodiment. The radiation-emitting device 7 comprises a semiconductor chip 8. During operation, the semiconductor chip 8 emits electromagnetic radiation of a first wavelength range. The semiconductor chip 8 comprises a substrate 10 on which an epitaxial semiconductor layer sequence 11 is grown. The epitaxial semiconductor layer sequence 11 comprises an active region 12, which generates the electromagnetic radiation of the first wavelength range during operation of the radiation-emitting device 7. The electromagnetic radiation of the first wavelength range is, for example, blue electromagnetic radiation. The electromagnetic radiation of the first wavelength range is emitted through a radiation exit surface of the semiconductor chip 7.

The radiation-emitting device further comprises a conversion element 9. The conversion element 9 is arranged on the radiation exit surface of the semiconductor chip 8. The conversion element 9 comprises a phosphor 1. In particular, it is possible that the conversion element 9 also comprises a further phosphor 13. The phosphor 1 converts the electromagnetic radiation of the first wavelength range into electromagnetic radiation of a second wavelength range, which is at least partially different from the electromagnetic radiation of the first wavelength range.

For example, the second wavelength range is the cyan to green or deep red to near-infrared wavelength range of the electromagnetic spectrum. The phosphor 13 converts the electromagnetic radiation of the first wavelength range into electromagnetic radiation of a third wavelength range, which is at least partially different from the electromagnetic radiation of the first wavelength range and/or the electromagnetic radiation of the second wavelength range.

A part of the electromagnetic radiation of the first wavelength range passes through the conversion element 9 without conversion. This means that the radiation-emitting device 7 emits a mixed light composed of the electromagnetic radiation of the first wavelength range, the second wavelength range and the third wavelength range.

For example, the phosphors 1 and/or 13 are phosphors described here with the general molecular formula EA₄Li₂D₄₋ₓEₓN₈₋ₓO₁₊ₓ:M, in particular Sr₄Li₂Si₄N₈O:Eu²⁺ and Sr₄Li₂Si₄N₈O:Ce³⁺.

The third wavelength range can comprise wavelengths in the green, yellow, orange and/or red spectral range. The further phosphor 13 can be a garnet-type phosphor or a garnet such as YAG, YAGaG, LuAG and/or LuAGaG, for example (Y, Lu)₃(Al, Ga)₅O₅₁₂:Ce³⁺. Alternatively or additionally, a red phosphor such as a 258-nitride, for example (Ca,Sr,Ba)₂Si₅N₈:Eu²⁺, and/or (S)CASN, for example (Ca,Sr)AlSiN₃:Eu²⁺, can be used as the further phosphor 13. The radiation-emitting device 7 then emits white light, for example. Such a device 7 is used, for example, in “human centric lighting” applications.

Alternatively, the third wavelength range can comprise wavelengths above 1000 nanometers. In other words, a further phosphor 13 is used in the conversion element, which emits IR radiation. As a result, the radiation emitted by the radiation-emitting device 7 at least partially covers the red, the deep red and the near-infrared spectral range, for example for spectroscopic examination in biological samples and for “IR-enhanced human centric lighting” applications, which in particular utilize the health-promoting effect of near-infrared radiation.

The features and exemplary embodiments described in connection with the figures may be combined with one another in accordance with further exemplary embodiments, even if not all combinations are explicitly described. Furthermore, the exemplary embodiments described in connection with the figures may alternatively or additionally comprise further features as described in the general part.

The present disclosure is not limited to the exemplary embodiments by the description thereof. Rather, the present disclosure includes any combination of features, which includes in particular any combination of features in the embodiments, even if this feature or combination itself is not explicitly stated in the exemplary embodiments.

### LIST OF REFERENCE SIGNS

1 phosphor
2 host lattice
3 SiN₄-tetrahedron
4 channel
5 Li atom
6 Sr atom
7 radiation-emitting device
8 semiconductor chip
9 conversion element
10 substrate
11 semiconductor layer sequence
12 active region
13 further phosphor
E1 emission spectrum of Sr₄Li₂Si₄N₈O:Eu²⁺
E2 emission spectrum of Sr₄Li₂Si₄N₈O:Ce³⁺
E3 emission spectrum of Sr₄Li₂Si₄N₈O:Ce³⁺
VB1 Emission spectrum of YAGaG:Ce³⁺
VB2 emission spectrum of LuAG:Ce³⁺
S1 first method step
S2 second method step
S3 third method step

1. A phosphor which obeys the general molecular formula EA₄Li₂D₄₋ₓEₓN₈₋ₓO₁₊ₓ:M wherein
EA is an element or a combination of elements selected from the group of divalent elements,
D is an element or a combination of elements selected from the group of tetravalent elements,
E is an element or a combination of elements selected from the group of trivalent elements,
M comprises an activator element, and
$$0 \leq x \leq 4 .$$

2. The phosphor according to claim 1, wherein
EA is an element or a combination of elements selected from the following group: Mg, Ca, Sr, Ba,
D is an element or a combination of elements selected from the following group: Si, Ge,
E is an element or a combination of elements selected from the following group: B, Al, Ga.

3. The phosphor according to claim 1, wherein M is an element or a combination of elements selected from the following group: Eu, Ce.

4. The phosphor according to claim 1, wherein the phosphor obeys the molecular formula EA₄Li₂Si₄N₈O:M, wherein EA is an element or a combination of elements selected from the following group: Mg, Ca, Sr, Ba.

5. The phosphor according to claim 1, wherein the phosphor obeys the molecular formula Sr₄Li₂Si₄N₈O:M.

6. The phosphor according to claim 1, wherein M comprises a molar proportion of between and including 0.01% and 10% based on the element EA.

7. The phosphor according to claim 1, wherein the phosphor comprises a host lattice with a tetragonal space group.

8. The phosphor according to claim 1, wherein the phosphor comprises an absorption range in the ultraviolet to blue wavelength range of the electromagnetic spectrum.

9. The phosphor according to claim 1, wherein
an electromagnetic radiation emitted by the phosphor comprises an emission spectrum with at least one emission peak, and
an emission maximum of the emission peak is in the cyan to green wavelength range of the electromagnetic spectrum.

10. The phosphor according to claim 1, wherein
an electromagnetic radiation emitted by the phosphor comprises an emission spectrum with at least one emission peak, and
an emission maximum of the emission peak is in the deep red to near-infrared wavelength range of the electromagnetic spectrum.

11. The phosphor according to claim 1, wherein the emission peak in the emission spectrum of the phosphor comprises a full-width at half maximum between and including 100 nanometers and 220 nanometers.

12. The phosphor according to claim 1, wherein the electromagnetic radiation emitted by the phosphor comprises a dominant wavelength λ_{dom} between and including 520 nanometers and 585 nanometers and/or a centroid wavelength λ_{centroid} between and including 795 nanometers and 845 nanometers.

13. A method for producing a phosphor which obeys the general molecular formula EA₄Li₂D₄₋ₓEₓN₈₋ₓO₁₋ₓ:M, wherein
EA is an element or a combination of elements selected from the group of divalent elements,
D is an element or a combination of elements selected from the group of tetravalent elements,
E is an element or a combination of elements selected from the group of trivalent elements,
M comprises an activator element, and
$$0 \leq x \leq 4 ,$$
comprising the steps:
providing reactants,
mixing the reactants to form a reactant mixture, and
heating the reactant mixture.

14. The method for producing a phosphor according to claim 13, wherein the reactants are selected from the following group: oxides, nitrides, fluorides, oxalates, citrates, carbonates, amines and imides of EA, Li, D, E and M.

15. The method for producing a phosphor according to claim 13, wherein the reactant mixture is heated at a pressure of at least 50 bar.

16. The method for producing a phosphor according to claim 13, wherein the reactant mixture is heated under an atmosphere of N₂, forming gas and/or NH₃.

17. The method for producing a phosphor according to claim 13, wherein the reactant mixture is heated to a temperature of at least 800° C.

18. A radiation-emitting device with:
a semiconductor chip which emits electromagnetic radiation of a first wavelength range during operation, and
a conversion element with a phosphor according to claim 1, which converts electromagnetic radiation of the first wavelength range into electromagnetic radiation of a second wavelength range which is at least partially different from the first wavelength range.

19. The radiation-emitting device according to claim 18, wherein the conversion element comprises at least one further phosphor which converts electromagnetic radiation of the first wavelength range into electromagnetic radiation of a third wavelength range which is at least partially different from the first and second wavelength ranges.
